(19) United States
(12) Patent Application Publication
(10) Pub. No.: US 2012/0159401 A1
(43) Pub. Date: Jun. 21, 2012

(54) Workspace Manipulation Using Mobile Device Gestures

(75) Inventors: Michel Pahud, Kirkland, WA (US); Ken Hinckley, Redmond, WA (US); William A. S. Buxton, Toronto (CA)

(73) Assignee: MICROSOFT CORPORATION, Redmond, WA (US)

(21) Appl. No.: 12/970,283

(22) Filed: Dec. 16, 2010

(51) Int. Cl. G06F 3/033

(52) U.S. Cl. 715/863

(57) ABSTRACT

Workspaces are manipulated on a mobile device having a display screen. A set of two or more discrete workspaces is established. A default discrete workspace is then displayed on the screen, where the default discrete workspace is one of the discrete workspaces in the set. Whenever a user gestures with the mobile device, the gesture is used to select one of the discrete workspaces from the set, and the selected discrete workspace will be displayed on the screen.

### BACKGROUND

Due to factors such as economic globalization and ongoing advances in computing, data communication, and computer networking technologies, human society across the globe is becoming increasingly mobile. Examples of such technology advances include the Internet, the World Wide Web, cellular wireless networks, hand-held computing devices and mobile computing applications. The Internet now serves billions of users worldwide and provides its users with access to a vast array of information resources and services, including those provided by the World Wide Web, intranet-based enterprises, and the like. Cellular wireless networks have evolved into a near ubiquitous infrastructure that provides wireless network access to users worldwide. Correspondingly, the number of cellular wireless network subscribers, and the number and types of cellular data services are growing rapidly. Various types of hand-held computing devices are now commercially available which enable users to affordably perform full-fledged computing and data communication activities while they are on the move. The latest generation of smartphones is one example of such devices. The types of mobile computing applications that are available to users continue to grow rapidly, as does the usage of these applications on smartphones. As a result, the number of users that regularly use a smartphone to access the Internet and run a variety of mobile computing applications is growing rapidly. In fact, smartphones have become a principal computing device for many users.

### SUMMARY

This Summary is provided to introduce a selection of concepts, in a simplified form, that are further described hereafter in the Detailed Description. This Summary is not intended to identify key features or essential features of the claimed subject matter, nor is it intended to be used as an aid in determining the scope of the claimed subject matter.

Workspace manipulation technique embodiments described herein generally involve workspace manipulation on a mobile device having a display screen. In an exemplary embodiment a set of two or more discrete workspaces is established. A default discrete workspace is then displayed on the screen, where the default discrete workspace is one of the discrete workspaces in the set. Whenever a user gestures with the mobile device, the gesture is used to select one of the discrete workspaces from the set, and the selected discrete workspace will be displayed on the screen.

### DESCRIPTION OF THE DRAWINGS

The specific features, aspects, and advantages of the workspace manipulation (WM) technique embodiments described herein will become better understood with regard to the following description, appended claims, and accompanying drawings where:

FIG. 1 is a diagram illustrating an exemplary embodiment, in simplified form, of an architectural framework for implementing the WM technique embodiments described herein.

FIG. 2 is a flow diagram illustrating one embodiment, in simplified form, of a process for workspace manipulation on a mobile device.

FIG. 3 is a diagram illustrating an exemplary embodiment of a circular ordered list of discrete workspaces.

FIG. 4 is a flow diagram illustrating an exemplary embodiment, in simplified form, of a process for using a gesture a mobile user makes with their mobile device to select one of the discrete workspaces from the circular ordered list of discrete workspaces.

FIG. 5 is a flow diagram illustrating an exemplary embodiment, in simplified form, of a process for adding a new private workspace to the circular ordered list of discrete workspaces.

FIG. 6 is a flow diagram illustrating another embodiment, in simplified form, of a process for workspace manipulation on a mobile device.

FIG. 7 is a diagram illustrating an exemplary embodiment of a virtual spatial layout of discrete workspaces.

FIG. 8 is a flow diagram illustrating one embodiment, in simplified form, of a process for using a gesture the mobile user makes with their mobile device to select one of the graphical symbols in a spatial layout of graphical symbols that provides an overview of the virtual spatial layout of discrete workspaces.

FIG. 9 is a flow diagram illustrating another embodiment, in simplified form, of a process for using a gesture the mobile user makes with their mobile device to select one of the graphical symbols in the spatial layout of graphical symbols.

FIG. 10 is a flow diagram illustrating yet another embodiment, in simplified form, of a process for workspace manipulation on a mobile device.

FIG. 11 is a diagram illustrating an exemplary embodiment, in simplified form, of a general purpose, network-based computing device which constitutes an exemplary system for implementing portions of the WM technique embodiments described herein.

### DETAILED DESCRIPTION

In the following description of workspace manipulation (WM) technique embodiments reference is made to the accompanying drawings which form a part hereof, and in which are shown, by way of illustration, specific embodiments in which the WM technique can be practiced. It is understood that other embodiments can be utilized and structural changes can be made without departing from the scope of the WM technique embodiments.

The term “mobile device” is used herein to refer to a hand-held computing device that is carried by a user and can run various mobile computing applications include ones which enable Internet access. As such, mobile devices are generally “pocket-sized.” Mobile devices may also include additional functionality such as the ability to operate as a telephone, and the like. Exemplary mobile devices include, but are not limited to, smartphones, tablet computers and personal digital assistants. Accordingly, the term “mobile user” is used herein to refer to a user who is on the move (i.e., who is traveling away from their home or workplace) and is utilizing a mobile device. The term “non-mobile computing device” is used herein to refer to a computing device that is larger than a mobile device and thus is generally not hand-held. Exemplary non-mobile computing devices include, but are not limited to, desktop personal computers (PCs) and laptop computers. Accordingly, the term “non-mobile user” is used herein to refer to a user who is not on the move but rather is located either at home or at their workplace (among other places) and thus is utilizing a non-mobile computing device.

If a person is right-handed then their right hand is referred to herein as their “dominant hand” and their left hand is referred to herein as their “non-dominant hand.” Similarly, if a person is left-handed then their left hand is referred to herein as their dominant hand and their right hand is referred to herein as their non-dominant hand.

### 1.0 Workspace Manipulation (WM) Using Mobile Device Gestures

Generally speaking, the WM technique embodiments described herein involve workspace manipulation on a mobile device having a display screen. In other words, the WM technique embodiments provide a mobile user who is utilizing the mobile device with various ways to manipulate a workspace on the mobile device's display screen. As described heretofore, the types of mobile computing applications that are available to mobile users continue to grow rapidly. As is appreciated in the art of mobile computing, a given mobile user can and often does run a plurality of different mobile computing applications at the same time on their mobile device. This enables the mobile user to concurrently perform a variety of computing tasks on their mobile device. As will be described in more detail hereafter, the mobile user can employ various methods to display and manipulate a plurality of discrete workspaces on the display screen of their mobile device, where each discrete workspace is generally associated with a particular mobile computing application.

The WM technique embodiments described herein are advantageous for a variety of reasons including, but not limited to, the following. As will be appreciated from the more detailed description that follows, the WM technique embodiments are easy to use, and are compatible with various conventional mobile devices, conventional non-mobile computing devices and conventional communication networks. The WM technique embodiments are also generally compatible with any mobile computing application the mobile user may want to run on their mobile device. The WM technique embodiments also generally optimize the efficiency of the mobile user when they are using their mobile device to concurrently perform a variety of computing tasks. More particularly, the WM technique embodiments allow the mobile user to concurrently run a plurality of different mobile computing applications on their mobile device, and easily, efficiently and intuitively switch between the different applications. In other words, despite the mobile device's small physical size, the WM technique embodiments optimize both the usability and multi-tasking capabilities of the mobile device, and accordingly optimize the mobile user's efficiency in completing desired tasks on the mobile device.

### 1.1 Architectural Framework

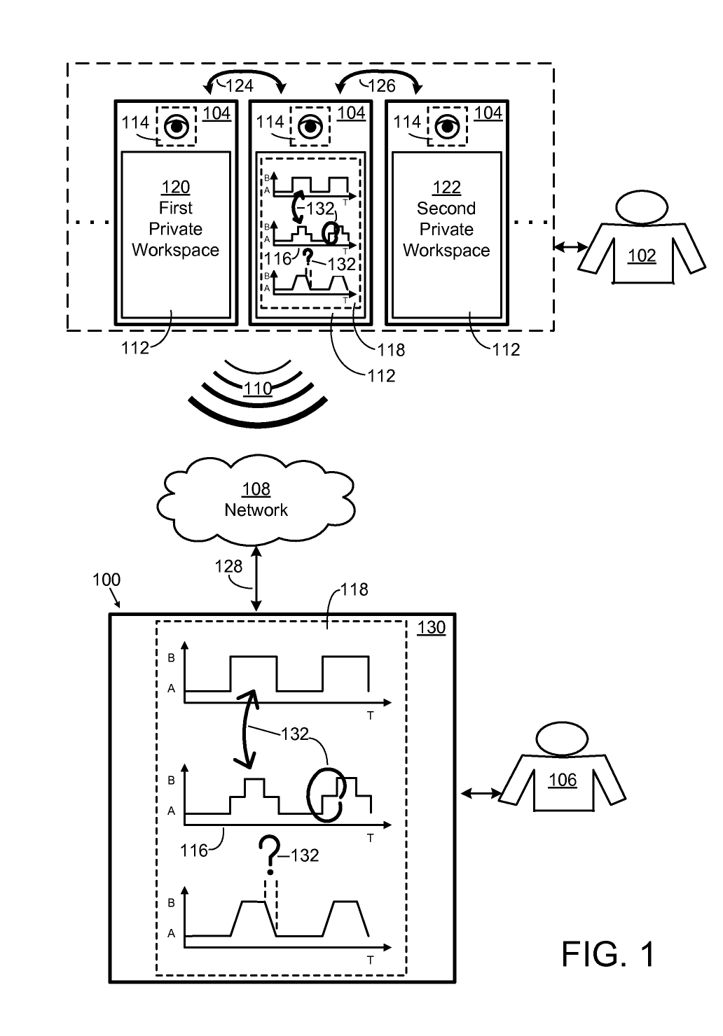

FIG. 1 illustrates an exemplary embodiment, in simplified form, of an architectural framework for implementing the WM technique embodiments described herein. The framework exemplified in FIG. 1 includes a mobile user 102 who is utilizing a mobile device 104 to run various mobile computing applications (hereafter simply referred to as “applications”) that will be described in more detail hereafter. During this utilization the mobile user 102 will generally either be holding the mobile device 104 in their non-dominant hand, or will place the mobile device on a table top in front of them. A remote user 106 is utilizing a non-mobile computing device 100 to run various non-mobile computing applications (hereafter also simply referred to as “applications”). The mobile device 104 and non-mobile computing device 100 are interconnected by a distributed communication network 108. As will be described in more detail hereafter, in one embodiment of the WM technique the mobile user 102 and remote user 106 can also use conventional methods to collaboratively view, manipulate and annotate 132 one or more data objects 116 in a shared workspace 118. Exemplary data objects 116 include, but are not limited to, documents, video, images, presentations, and other types of data which can be specific to a given application such as a calendar, email, and the like.

Referring again to FIG. 1, it is noted that alternate embodiments (not shown) of the architectural framework exemplified in FIG. 1 are also possible. By way of example, but not limitation, the framework can include additional mobile users who are utilizing additional mobile devices. The framework can also include additional remote users who are utilizing additional non-mobile computing devices. Additionally, a second mobile user who is utilizing a second mobile device can be substituted for the remote user 106 and their non-mobile computing device 100.

Referring again to FIG. 1, the mobile device 104 is connected to the distributed communication network 108 via a conventional wireless connection 110. As is appreciated in the art of communication networks, the network 108 can be either a public communication network such as the Internet (among others), or a private communication network such as an intranet (among others). The wireless connection 110 can be implemented in various ways depending on the particular type of mobile device 104 that is being utilized by the mobile user 102 and the types of wireless network service that are available in the particular location where the mobile user happens to be situated at the time. By way of example but not limitation, the wireless connection 110 can be a Wi-Fi local area network (LAN) connection to a Wi-Fi access point device (not shown). The wireless connection 110 can also be a cellular wide area network (WAN) connection which supports one or more different mobile telecommunication data services such as GPRS (general packet radio service—also known as “2.5G”), EDGE (enhanced data rates for GSM (global system for mobile communications) evolution—also known as “2.75G”), and 3G (third generation).

Referring again to FIG. 1, the mobile device 104 includes various functional components which are integrated there-within. Examples of these functional components include, but are not limited to, one or more compact display screens 112, an optional front-facing video capture device 114 (such as a compact video camera and the like), and an optional audio output device (not shown) (such as one or more compact loudspeakers and the like). The audio output device includes one or more audio channels which are used to output prescribed types of audio information for the mobile user 102 to hear. It will be appreciated that these audio channels can be connected to a variety of audio reproduction devices such as one or more loudspeakers, an earphone, a pair of headphones, and the like. In an exemplary embodiment of the WM technique described herein the mobile device's display screen 112 is touch-sensitive and/or supports a pen device or the like. An alternate embodiment of the WM technique is also possible where the mobile device's display screen 112 is not touch-sensitive. The mobile device may also include additional functionality integrated there-within that enables it to operate as a telephone.

Referring again to FIG. 1, various types of information can be displayed on the mobile device's display screen 112 including, but not limited to, the aforementioned plurality of discrete workspaces. FIG. 1 illustrates three such discrete workspaces, namely the aforementioned shared workspace 118, a first private workspace 120 and an second private workspace 122. As will be described in more detail hereafter, the mobile user can also create new private workspaces, where, in an exemplary instance, each new private workspace is associated with a particular mobile computing application or a particular data object that the mobile user has opened using a particular application. The mobile user can also create new shared workspaces in order to support collaborative scenarios where a plurality of shared workspaces is desired. As will also be described in more detail hereafter, in one embodiment of the WM technique described herein the mobile user 102 can change what is displayed on the mobile device's display screen 112 by gesturing 124/126 with the mobile device 104 in prescribed ways. In another embodiment of the WM technique where the mobile device's display screen 112 is touch-sensitive the mobile user 102 can change what is displayed on the screen by using a pointing device (not shown) on the screen.

Referring again to FIG. 1, the mobile device 104 also includes motion-sensing functionality. In an exemplary embodiment of the WM technique described herein, the motion-sensing functionality is provided by a dedicated motion-sensing device (not shown) that is also integrated within the mobile device 104. This dedicated motion-sensing device senses the spatial orientation of the mobile device 104 and measures the direction (among other things) of any physical movement of the mobile device. As will be described in more detail hereafter, the mobile device 104 uses this spatial orientation and movement information for various purposes such as controlling its graphical user interface (GUI), and dynamically adapting how the plurality of discrete workspaces are presented/displayed to the mobile user 102. An accelerometer is commonly employed as the dedicated motion-sensing device, although other types of motion-sensing devices could also be used. It is noted that the mobile device's 104 motion-sensing capabilities can be enabled and disabled by the mobile user 102.

Referring again to FIG. 1, an alternate embodiment of the WM technique described herein is also possible where the motion-sensing functionality is provided using the video capture device 114 combined with conventional video processing methods. Another alternate embodiment of the WM technique is also possible where the motion-sensing functionality is provided using a combination of the dedicated motion-sensing device, video capture device 114 and conventional video processing methods.

Referring again to FIG. 1, the non-mobile computing device 100 is connected to the distributed communications network 108 via either a conventional wired connection 128 or a conventional wireless connection (not shown). The non-mobile computing device 100 includes various functional components such as one or more display devices 130, among others. Various types of information can be displayed on the non-mobile computing device's display device 130 including, but not limited to, the aforementioned shared workspace 118 (as shown in FIG. 1).

### 1.2 Circular Ordered List of Discrete Workspaces

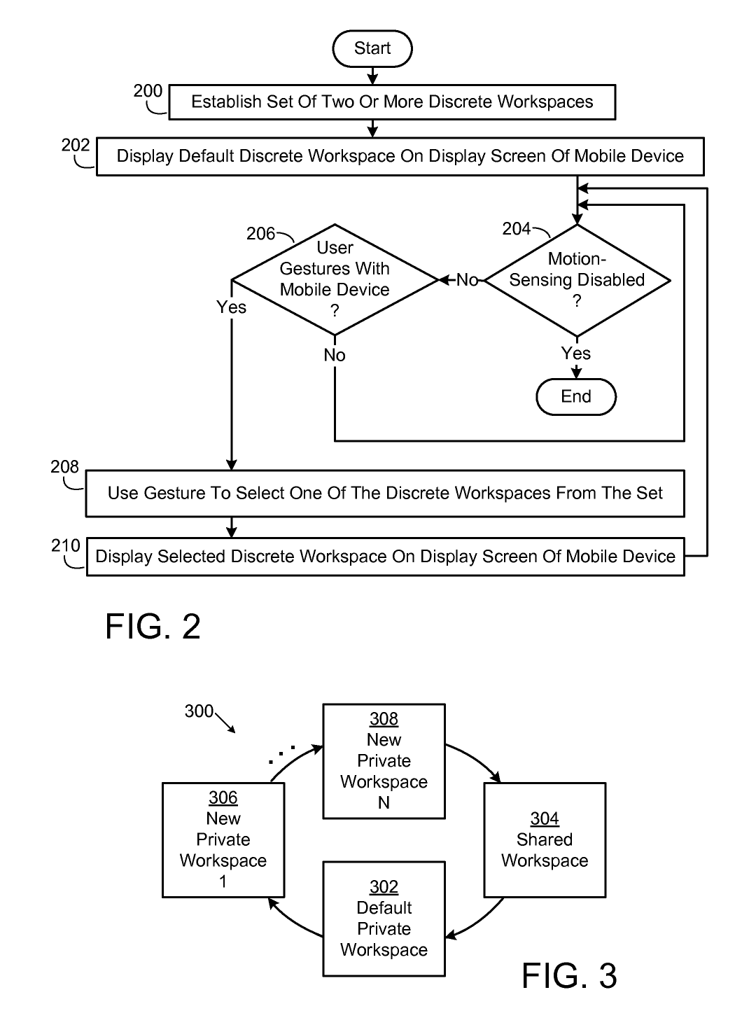

FIG. 2 illustrates one embodiment, in simplified form, of a process for workspace manipulation on a mobile device. As exemplified in FIG. 2, the process starts in block 200 with establishing a set of two or more discrete workspaces. In an exemplary embodiment of the WM technique described herein these discrete workspaces initially include a default private workspace and a shared workspace. The default private workspace is displayed on just the mobile device's display screen. Accordingly, the default private workspace can be viewed and manipulated by just the mobile user (i.e., it is private to the mobile user). In contrast, the shared workspace can be collaboratively viewed, manipulated and annotated by the mobile user and one or more remote users (each of whom are utilizing a computing device which can be either a mobile device or a non-mobile computing device that is connected to the mobile user's mobile device via the aforementioned distributed communication network) using conventional methods. Accordingly, any user can display data objects in the shared workspace, and any user can generate annotations in the shared workspace, and these data objects and annotations can be collaboratively viewed, manipulated and annotated by the other users. This of course assumes that the user who owns the data objects being collaboratively displayed/manipulated/annotated authorizes the other users to perform these actions on the data objects.

Referring again to FIG. 2, once the set of two or more discrete workspaces is established (block 200), a default discrete workspace is initially displayed on the mobile device's display screen (block 202), where the default discrete workspace is one of the discrete workspaces in the set. Assuming the mobile device's motion-sensing capabilities are enabled (block 204, No), whenever the mobile user gestures with the mobile device (block 206, Yes), the gesture is used to select one of the discrete workspaces from the set (block 208). The selected discrete workspace will then be displayed on the screen (block 210). This action of displaying the selected discrete workspace can optionally include providing haptic feedback to the mobile user to notify them that what is displayed on the screen has changed. The actions of blocks 204-210 are repeated until the mobile device's motion-sensing capabilities are disabled (block 204, Yes).

The default discrete workspace that is initially displayed on the mobile device's display screen can be any one of the discrete workspaces in the set of two or more discrete workspaces. The default discrete workspace that is initially displayed generally depends on the operating context of the mobile device, and can also depend on the preference of the mobile user. In an exemplary embodiment of the WM technique described herein, whenever the mobile device is operating in a collaborative mode (which is the case when the mobile user is utilizing the mobile device to perform a collaborative computing task such as participating in a telepresence session with one or more remote users, or participating in another type of online meeting with one or more remote users, among other collaborative computing tasks), the default discrete workspace that is initially displayed is the shared workspace. Whenever the mobile device is not operating in a collaborative mode (which is often the case), the default discrete workspace that is initially displayed is the default private workspace. Alternate embodiments of the WM technique are also possible where other discrete workspaces are initially displayed as the default discrete workspace in these different modes.

In an exemplary embodiment of the WM technique described herein the default private workspace is a “desktop” environment for the mobile device which generally provides the mobile user with a GUI environment that is similar to a conventional personal computing desktop environment. More particularly, the desktop environment for the mobile device provides the mobile user with a GUI that allows the user to intuitively and efficiently access and operate popular computing features and functionality of the mobile device. It is noted that other embodiments of the WM technique are also possible where the default private workspace can be any other type of private workspace. For example, in an alternate embodiment of the WM technique the default private workspace can be associated with a particular application the mobile user regularly utilizes (e.g., the mobile user's favorite application). Examples of such an application include an email application, a calendaring application, a document creation/editing application, or a web browsing application, among others.

In one embodiment of the WM technique described herein the set of two or more discrete workspaces is stored as a circular ordered list of discrete workspaces. This list generally operates as a carousel of currently active discrete workspaces. As will now be described in more detail, the mobile user can sequentially display each of the discrete workspaces in the list (i.e., the user can cycle through the carousel) by gesturing with the mobile device in prescribed ways. The mobile user can also add new discrete workspaces to the list, and remove existing discrete workspaces from the list.

FIG. 3 illustrates an exemplary embodiment of the circular ordered list of discrete workspaces. As exemplified in FIG. 3 the circular ordered list of discrete workspaces 300 is initially populated with the default private workspace 302 and the shared workspace 304. As will be described in more detail hereafter, the mobile user can then add one or more new private workspaces 306 and 308 to the list 300.

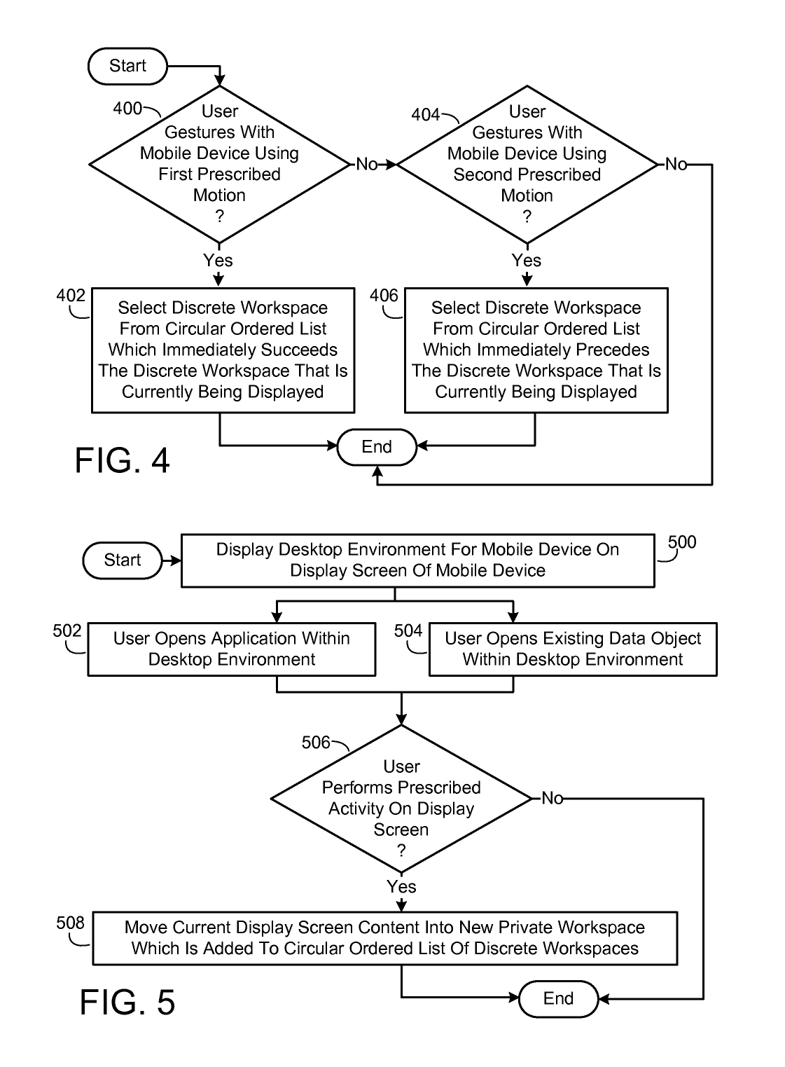

FIG. 4 illustrates an exemplary embodiment, in simplified form, of a process for using the gesture the mobile user makes with their mobile device to select one of the discrete workspaces from the set of two or more discrete workspaces that is stored as a circular ordered list of discrete workspaces. As exemplified in FIG. 4, whenever the mobile user gestures with the mobile device using a first prescribed motion (block 400, Yes), the discrete workspace from the list which immediately succeeds the discrete workspace that is currently being displayed on the mobile device's display screen will be selected (block 402). Whenever the mobile user gestures with the mobile device using a second prescribed motion (block 404, Yes), the discrete workspace from the list which immediately precedes the discrete workspace that is currently being displayed on the screen will be selected (block 406). By way of further clarification but not limitation, and as exemplified in FIG. 3, if the default private workspace 302 is currently being displayed on the screen and the mobile user gestures with the mobile device using the first prescribed motion, new private workspace 1 306 will be selected. If the default private workspace 302 is currently being displayed on the screen and the mobile user gestures with the mobile device using the second prescribed motion, the shared workspace 304 will be selected.

In one intuitive embodiment of the WM technique described herein the first prescribed motion is a leftward motion and the second prescribed motion is a rightward motion (from the perspective of the mobile user who is holding the mobile device). In one implementation of this embodiment the leftward motion is the mobile device being tilted about its left edge (i.e., the mobile user rotating the mobile device counterclockwise about its upward-facing vertical axis), and the rightward motion is the mobile device being tilted about its right edge (i.e., the mobile user rotating the mobile device clockwise about its upward-facing vertical axis). In another implementation of this embodiment the leftward motion is the mobile device being moved horizontally leftward from its vertical axis and the rightward motion is the mobile device being moved horizontally rightward from its vertical axis.

In another intuitive embodiment of the WM technique described herein the first prescribed motion is an upward motion and the second prescribed motion is a downward motion (from the perspective of the mobile user who is holding the mobile device). In one implementation of this embodiment the upward motion is the mobile device being tilted about its top edge, and the downward motion is the mobile device being tilted about its bottom edge. In another implementation of this embodiment the upward motion is the mobile device being moved vertically upward from its horizontal axis and the downward motion is the mobile device being moved vertically downward from its horizontal axis.

In an exemplary embodiment of the WM technique described herein the default private workspace can be automatically displayed whenever the mobile device is physically oriented in a first prescribed position. The shared workspace can be automatically displayed whenever the mobile device is physically oriented in a second prescribed position that is different than the first prescribed position. In one implementation of this embodiment the first prescribed position is the mobile device being oriented and/or positioned along a vertical plane, and the second prescribed position is the mobile device being oriented and/or positioned along a horizontal plane (such as the mobile device sitting on a table). In another implementation of this embodiment the first prescribed position is the mobile device being oriented and/or positioned along a horizontal plane and the second prescribed position is the mobile device being oriented and/or positioned along a vertical plane.

As described heretofore, whenever the mobile user is utilizing their mobile device they generally either hold it in their non-dominant hand or place it on a table top in front of them, which leaves their dominant hand free. As such and generally speaking, in the aforementioned case where the mobile device's display screen is touch-sensitive the mobile user can utilize their dominant hand to manipulate/annotate the discrete workspace that is currently being displayed on the screen in various ways. More particularly, in one embodiment of the WM technique described herein the mobile user can manipulate/annotate the discrete workspace that is currently being displayed by utilizing a pointing device which physically contacts the screen. In one implementation of this embodiment the pointing device can be a pen that the mobile user holds in their dominant hand. In another implementation of this embodiment the pointing device can be one or more fingers on the mobile user's dominant hand. Additional implementations of this embodiment are also possible where other types of pointing devices are employed by the mobile user. In another embodiment of the WM technique the mobile user can manipulate the displayed discrete workspace by physically contacting the screen using one or more fingers on their dominant hand, and the mobile user can annotate the displayed discrete workspace by physically contacting the screen using a pen that they hold in their dominant hand.

Whenever the mobile device's display screen is touch-sensitive and a data object is present in a particular discrete workspace that is currently being displayed on the screen, the mobile user can utilize the pointing device on the screen in various ways to copy the data object to another discrete workspace. Examples of such ways include, but are not limited to, the following. In one embodiment of the WM technique described herein, whenever the mobile user touches a data object that is displayed on the screen and then drags the data object along the screen (i.e., “flicks” the data object) in a direction that is associated with the aforementioned first prescribed motion, a copy of the data object will be put into the discrete workspace from the aforementioned circular ordered list which immediately succeeds the discrete workspace that is currently being displayed (hereafter also simply referred to as the “succeeding discrete workspace”). Correspondingly, whenever the mobile user touches the data object and then drags it along the screen in a direction that is associated with the aforementioned second prescribed motion, a copy of the data object will be put into the discrete workspace from the aforementioned circular ordered list which immediately precedes the discrete workspace that is currently being displayed (hereafter also simply referred to as the “preceding discrete workspace”). In one implementation of this embodiment the screen will remain unchanged. In another implementation of this embodiment either the succeeding or preceding discrete workspace into which the data object is put will be displayed on the screen. In another embodiment of the WM technique, whenever the mobile user touches a data object that is displayed on the screen and the mobile user then gestures with the mobile device using the first prescribed motion, a copy of the data object will be put into the succeeding discrete workspace. Correspondingly, whenever the mobile user touches the data object, and the mobile user then gestures with the mobile device using the second prescribed motion, a copy of the data object will be put into the preceding discrete workspace. In one implementation of this embodiment the screen will remain unchanged. In another implementation of this embodiment either the succeeding or preceding discrete workspace into which the data object is put will be displayed on the screen.

The aforementioned haptic feedback can be provided to the mobile user at any time during the transition between the old content that was previously being displayed on the mobile device's display screen and the new content that is currently being displayed (e.g., the haptic feedback can be provided either in the middle of the transition, or once the new content is fully displayed, among other times during the transition). The haptic feedback can also be provided to the mobile user in various ways. In one embodiment of the WM technique described herein where the mobile device includes a vibration motor which is optionally integrated within the mobile device, the haptic feedback can be provided by stimulating the vibration motor for a prescribed brief period of time. In an exemplary embodiment of the WM technique this period of time is 0.3 seconds. In another embodiment of the WM technique the haptic feedback can be accompanied by either audio feedback, or video feedback, or both audio and video feedback.

FIG. 5 illustrates an exemplary embodiment, in simplified form, of a process for adding a new private workspace to the circular ordered list of discrete workspaces. As exemplified in FIG. 5, the process starts in block 500 with the aforementioned desktop environment for the mobile device being displayed on the display screen of the mobile device. After the mobile user either opens an application within the desktop environment (block 502), or opens an existing data object within the desktop environment (block 504), and whenever the mobile user performs a prescribed activity on the screen (block 506), the current screen content is moved into a new private workspace which is added to the circular ordered list of discrete workspaces (block 508). The new private workspace can be added at various places in the circular ordered list, such as at the end of the list, or the beginning of the list, or anywhere else in the list that the mobile user desires. It is noted that the mobile user can also re-order the existing discrete workspaces within the circular ordered list as desired. The prescribed activity can be various things including, but not limited to, the following. In one embodiment of the WM technique described herein the prescribed activity is the mobile user holding the pointing device on the screen while they gesture with the mobile device using either the first prescribed motion or second prescribed motion. In another embodiment of the WM technique the prescribed activity is the mobile user dragging the pointing device along the screen in a direction that is associated with either the first prescribed motion or second prescribed motion. In an exemplary embodiment of the WM technique, whenever the mobile user either closes an application or a data object that is associated with a particular private workspace, the particular private workspace can be automatically removed from the circular ordered list of discrete workspaces.

### 1.3 Virtual Spatial Layout of Discrete Workspaces

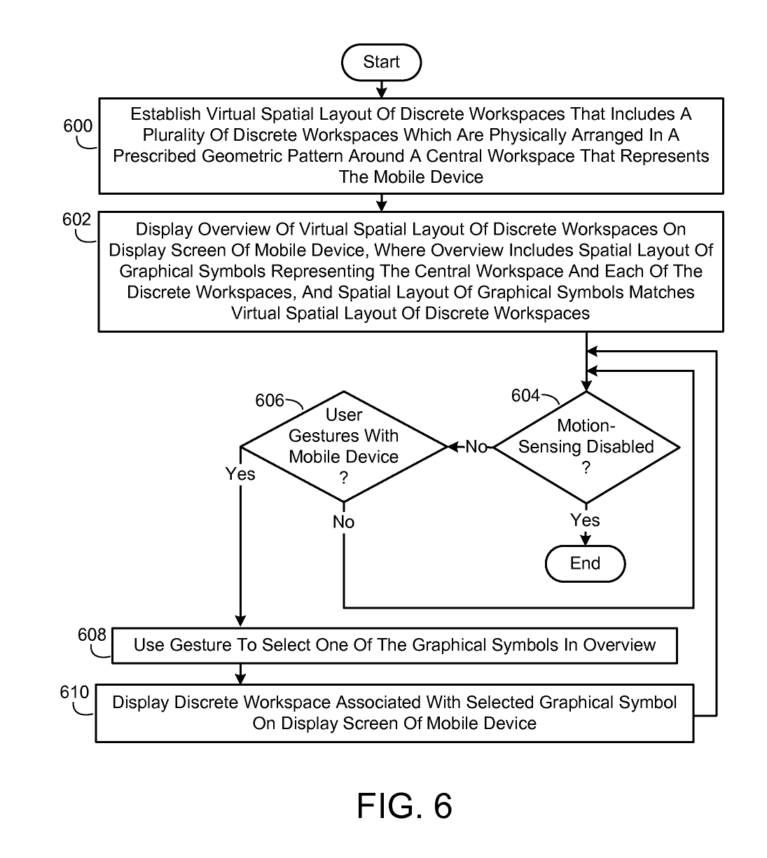

FIG. 6 illustrates another embodiment, in simplified form, of a process for workspace manipulation on a mobile device. Generally speaking, rather than the set of two or more discrete workspaces being stored in a circular ordered list of discrete workspaces as described heretofore, in this embodiment of the WM technique described herein the discrete workspaces are physically arranged in a virtual spatial layout. As exemplified in FIG. 6, the process starts in block 600 with establishing a virtual spatial layout of discrete workspaces, where the layout includes a plurality of discrete workspaces which are physically arranged in a prescribed geometric pattern around a central workspace that represents the mobile device. In other words, the central workspace represents what currently is or will be displayed on the mobile device's display screen. In an exemplary embodiment of the WM technique these discrete workspaces include the aforementioned default private workspace and shared workspace. An overview of the virtual spatial layout of discrete workspaces is then displayed on the screen (block 602). This overview includes a spatial layout of graphical symbols representing the central workspace and each of the discrete workspaces. The spatial layout of graphical symbols matches the virtual spatial layout of discrete workspaces such that the overview shows the spatial relationship of each discrete workspace to the central workspace, and also shows the spatial interrelationships between the plurality of discrete workspaces. Thus, the overview provides the mobile user with a “zoomed out” macro view of these spatial relationships.

Referring again to FIG. 6, assuming the mobile device's motion-sensing capabilities are enabled (block 604, No), whenever the mobile user gestures with the mobile device (block 606, Yes), the gesture will be used to select one of the graphical symbols in the overview (block 608). The discrete workspace that is associated with the selected graphical symbol is then displayed on the display screen (block 610). This action of displaying the discrete workspace associated with the selected graphical symbol can optionally include providing the aforementioned haptic feedback to the mobile user. The actions of blocks 604-610 are repeated until the mobile device's motion-sensing capabilities are disabled (block 604, Yes).

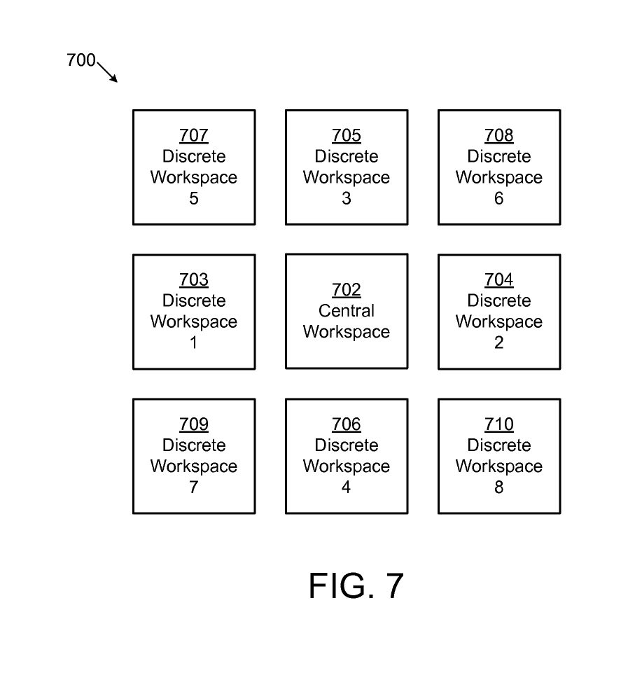

FIG. 7 illustrates an exemplary embodiment of the virtual spatial layout of discrete workspaces. As exemplified in FIG. 7 the virtual spatial layout of discrete workspaces 700 includes the central workspace 702 around which eight discrete workspaces 703-710 are physically arranged. The nine total discrete workspaces 702-710 are physically arranged in the pattern of a 3×3 array. One of the discrete workspaces (such as discrete workspace 1 703, among others) can optionally be initially populated with the default private workspace, and another one of the discrete workspaces (such as discrete workspace 2 704, among others) can optionally be initially populated with the shared workspace. It is noted that various alternate embodiments (not shown) of the virtual spatial layout of discrete workspaces are also possible. For example, the total number of discrete workspaces in the layout can be either less than or greater than the nine discrete workspaces exemplified in FIG. 7. The discrete workspaces can also be physically arranged in other geometric patterns such as a non-symmetrical two-dimensional array, a one-dimensional vertical array, and a one-dimensional horizontal array, among others. Additionally, the virtual spatial layout of discrete workspaces can also be implemented in a circular manner. In other words, in this implementation discrete workspace 4 706 would be virtually located above discrete workspace 3 705, and discrete workspace 1 703 would be virtually located to the right of discrete workspace 2 704.

The graphical symbols representing the central workspace and each of the discrete workspaces can be implemented in various ways including, but not limited to, the following. In one embodiment of the WM technique described herein the graphical symbols are implemented as thumbnails. In another embodiment of the WM technique the graphical symbols are implemented as icons. In yet another embodiment of the WM technique the graphical symbols are implemented as tiles.

In an exemplary embodiment of the WM technique described herein the graphical symbol representing the central workspace is highlighted in order to visually distinguish it from the graphical symbols representing the discrete workspaces. This highlighting can be done in a variety of ways including, but not limited to, the following. In one embodiment of the WM technique the highlighting is done by displaying a colored border around the perimeter of the graphical symbol representing the central workspace. In another embodiment the highlighting is done by displaying a highlight having a visually distinguishable color over this graphical symbol.

Whenever the mobile device's display screen is touch-sensitive and the overview of the virtual spatial layout of discrete workspaces is displayed on the screen, the mobile user can utilize the pointing device on the screen to modify the spatial layout of graphical symbols, thus modifying the virtual spatial layout of the discrete workspaces. In other words, the mobile user can manually re-arrange the physical positions of the discrete workspaces in the layout of discrete workspaces by touching the graphical symbol representing a desired discrete workspace and then dragging the symbol along the screen to a desired new physical position in the layout of graphical symbols.

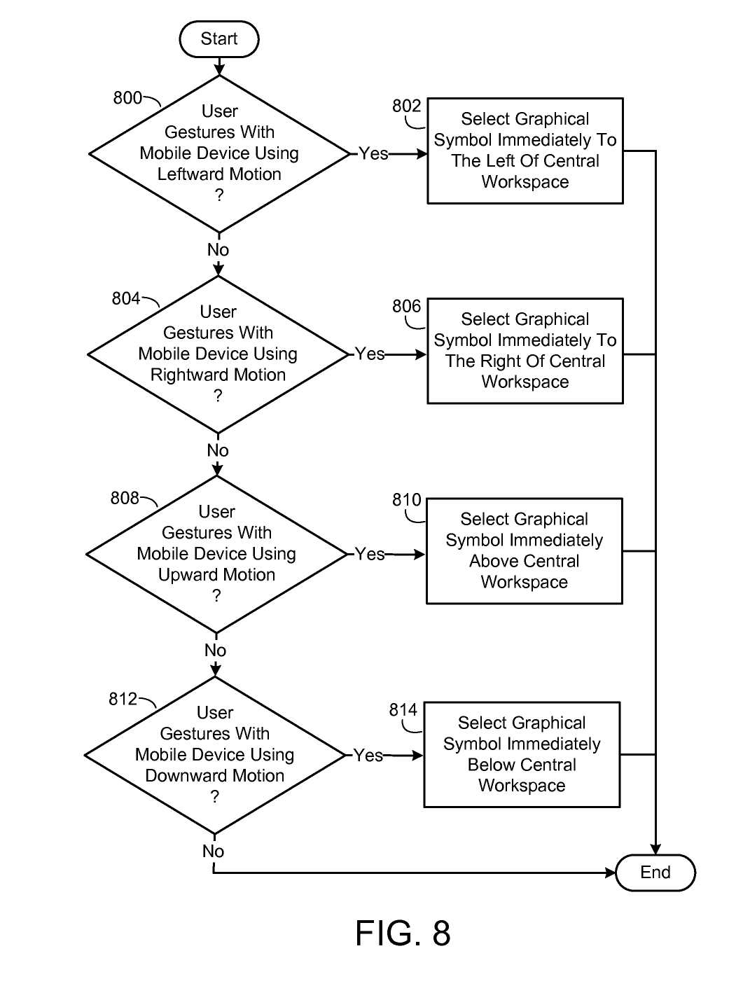

FIG. 8 illustrates one embodiment, in simplified form, of a process for using the gesture the mobile user makes with their mobile device to select one of the graphical symbols in the overview of the virtual spatial layout of discrete workspaces. As exemplified in FIG. 8, whenever the user gestures with the mobile device using a leftward motion (block 800), the graphical symbol immediately to the left of the central workspace will be selected (block 802). Whenever the user gestures with the mobile device using a rightward motion (block 804), the graphical symbol immediately to the right of the central workspace will be selected (block 806). Whenever the user gestures with the mobile device using an upward motion (block 808), the graphical symbol immediately above the central workspace will be selected (block 810). Whenever the user gestures with the mobile device using a downward motion (block 812), the graphical symbol immediately below the central workspace will be selected (block 814).

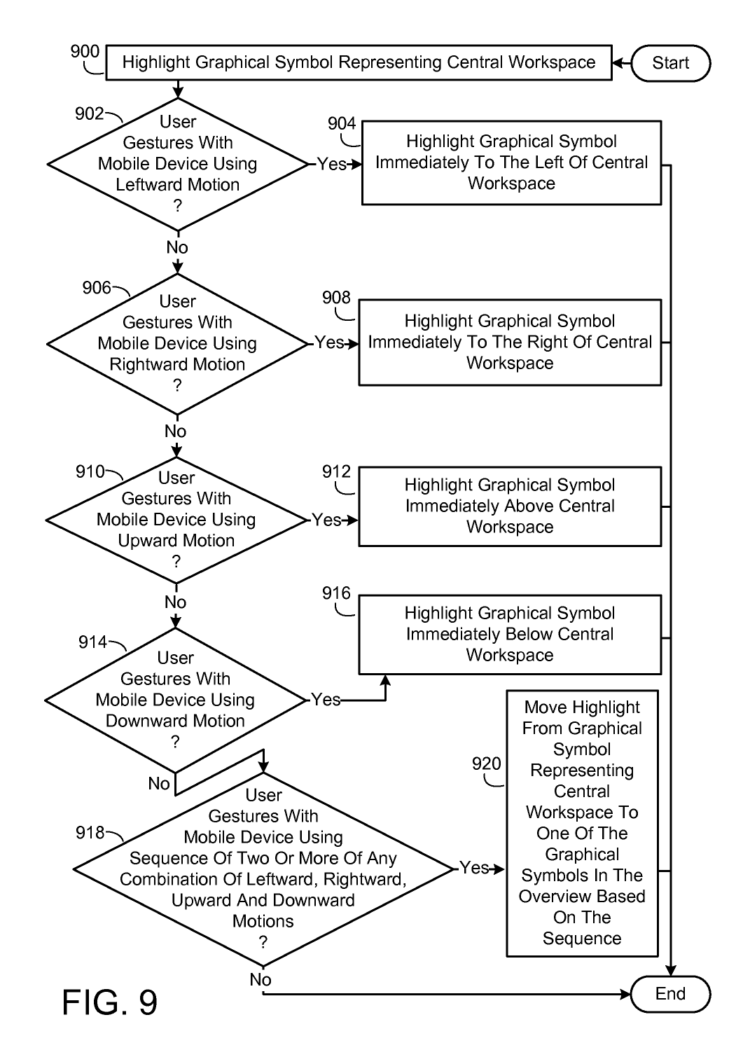

FIG. 9 illustrates another embodiment, in simplified form, of a process for using the gesture the mobile user makes with their mobile device to select one of the graphical symbols in the overview of the virtual spatial layout of discrete workspaces. As exemplified in FIG. 9, the process starts in block 900 with highlighting the graphical symbol representing the central workspace. Then, whenever the user gestures with the mobile device using a leftward motion (block 902), the graphical symbol immediately to the left of the central workspace will be highlighted (block 904). Whenever the user gestures with the mobile device using a rightward motion (block 906), the graphical symbol immediately to the right of the central workspace will be highlighted (block 908). Whenever the user gestures with the mobile device using an upward motion (block 910), the graphical symbol immediately above the central workspace will be highlighted (block 912). Whenever the user gestures with the mobile device using a downward motion (block 914), the graphical symbol immediately below the central workspace will be highlighted (block 916). Whenever the user gestures with the mobile device using a sequence of two or more of any combination of the leftward, rightward, upward and downward motions (block 918), the highlight will be moved from the graphical symbol representing the central workspace to one of the graphical symbols in the overview based on the sequence of motions (block 920). By way of further clarification but not limitation, and referring again to FIG. 7, if the user gestures with the mobile device using an upward motion, the graphical symbol representing discrete workspace 3 705 will be highlighted. If the user gestures with the mobile device using a leftward motion followed by a downward motion, the graphical symbol representing discrete workspace 7 709 will be highlighted.

Once one of the graphical symbols in the overview has been highlighted based on the user gesturing with their mobile device as just described, the user can display the discrete workspace associated with the highlighted graphical symbol on the mobile device's display screen by gesturing with the mobile device using a zoom-in motion (which is different than the leftward, rightward, upward and downward motions). Whenever a given discrete workspace is displayed on the screen, the user can re-display the overview of the virtual spatial layout of discrete workspaces on the screen by gesturing with the mobile device using a zoom-out motion (which is also different than the leftward, rightward, upward and downward motions). In one intuitive embodiment of the WM technique described herein where the prescribed geometric pattern is a two-dimensional array of discrete workspaces, the zoom-in motion can be the mobile device being moved away from the mobile user, and the zoom-out motion can be the mobile device being moved toward the mobile user, or vice versa. In another intuitive embodiment of the WM technique described herein where the prescribed geometric pattern is a one-dimensional vertical array of discrete workspaces so that the user selects one of the graphical symbols in the overview by gesturing with the mobile device using either an upward motion or a downward motion, the zoom-in motion can be the mobile device being moved leftward, and the zoom-out motion can be the mobile device being moved rightward, or vice versa. In yet another intuitive embodiment of the WM technique described herein where the prescribed geometric pattern is a one-dimensional horizontal array of discrete workspaces so that the user selects one of the graphical symbols in the overview by gesturing with the mobile device using either a leftward motion or a rightward motion, the zoom-in motion can be the mobile device being moved upward, and the zoom-out motion can be the mobile device being moved downward, or vice versa.

Whenever the mobile device's display screen is touch-sensitive and a data object is present in a particular discrete workspace that is currently being displayed on the screen, the mobile user can utilize the pointing device on the screen in various ways to copy the data object to another discrete workspace. In an exemplary embodiment of the WM technique described herein, whenever the mobile user touches the data object and then drags it along the screen in a particular direction, this direction is used to select one of the discrete workspaces in the virtual spatial layout, and a copy of the data object is put into the selected discrete workspace. By way of example but not limitation and referring again to FIG. 7, assume a situation where the virtual spatial layout of discrete workspaces is a 3×3 array as exemplified in FIG. 7. In this situation, whenever the mobile user touches the data object and then drags it along the screen in a leftward direction, a copy of the data object is put into discrete workspace 1 703. Whenever the mobile user touches the data object and then drags it along the screen in a rightward direction, a copy of the data object is put into discrete workspace 2 704. Whenever the mobile user touches the data object and then drags it along the screen in an upward direction, a copy of the data object is put into discrete workspace 3 705. Whenever the mobile user touches the data object and then drags it along the screen in a downward direction, a copy of the data object is put into discrete workspace 4 706. Whenever the mobile user touches the data object and then drags it along the screen in a diagonally northwestward direction, a copy of the data object is put into discrete workspace 5 707. Whenever the mobile user touches the data object and then drags it along the screen in a diagonally northeastward direction, a copy of the data object is put into discrete workspace 6 708. Whenever the mobile user touches the data object and then drags it along the screen in a diagonally southwestward direction, a copy of the data object is put into discrete workspace 7 709. Whenever the mobile user touches the data object and then drags it along the screen in a diagonally southeastward direction, a copy of the data object is put into discrete workspace 8 710.

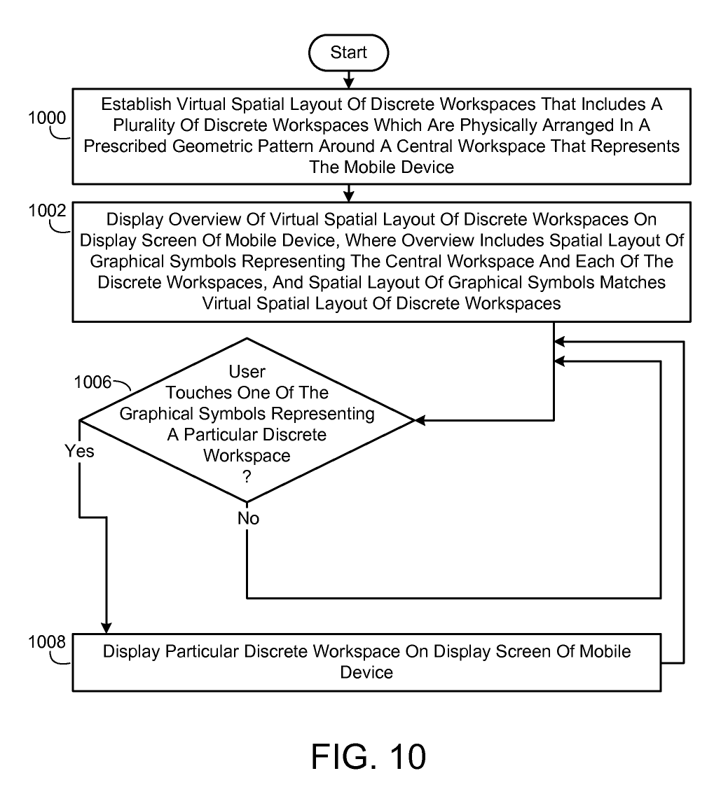

FIG. 10 illustrates yet another embodiment, in simplified form, of a process for workspace manipulation on a mobile device, where this embodiment is based on the mobile device having a touch-sensitive display screen, and is also based on the discrete workspaces being physically arranged in a virtual spatial layout. As exemplified in FIG. 10, the process starts in block 1000 with establishing the virtual spatial layout of discrete workspaces. In an exemplary embodiment of the WM technique described herein these discrete workspaces include the default private workspace and shared workspace. The overview of the virtual spatial layout of discrete workspaces is then displayed on the mobile device's display screen (block 1002). Then, whenever the mobile user touches one of the graphical symbols representing a particular discrete workspace (block 1006, Yes), the particular discrete workspace will be displayed on the screen (block 1008).

Generally speaking and in relation to the WM technique embodiment exemplified in FIG. 10, once a given discrete workspace is displayed on the mobile device's display screen, the mobile user can employ various methods to display a different discrete workspace on the screen. Examples of such methods include, but are not limited to, the following. In one embodiment of the WM technique described herein, whenever the mobile user gestures with the mobile device using the zoom-out motion, the overview of the virtual spatial layout of discrete workspaces is re-displayed on the screen. Then, in one implementation, whenever the mobile user touches one of the graphical symbols representing a desired discrete workspace, and then drags this symbol along the screen, and then releases this symbol on top of the graphical symbol representing the central workspace, the desired discrete workspace is displayed on the screen. In an alternate implementation, whenever the mobile user simply touches one of the graphical symbols representing a desired discrete workspace, the desired discrete workspace is displayed on the screen. In another embodiment of the WM technique, assuming a given discrete workspace is currently being displayed on the screen, whenever the mobile user drags a pointing device in a particular direction on the screen, this direction is used to select one of the discrete workspaces in the virtual spatial layout, and the selected discrete workspace is displayed on the screen. By way of example but not limitation, assume a situation where the virtual spatial layout of discrete workspaces is a two-dimensional array of discrete workspaces (such as the array exemplified in FIG. 7, among other possible arrays). In this situation, whenever the mobile user drags the pointing device leftward on the screen, the discrete workspace immediately to the left of the given discrete workspace is displayed on the screen (if there is no discrete workspace to the left of the given discrete workspace in the layout then the given discrete workspace will remain on the screen). Whenever the mobile user drags the pointing device rightward on the screen, the discrete workspace immediately to the right of the given discrete workspace is displayed on the screen (if there is no discrete workspace to the right of the given discrete workspace in the layout then the given discrete workspace will remain on the screen). Whenever the mobile user drags the pointing device upward on the screen, the discrete workspace immediately above the given discrete workspace is displayed on the screen (if there is no discrete workspace above the given discrete workspace in the layout then the given discrete workspace will remain on the screen). Whenever the mobile user drags the pointing device downward on the screen, the discrete workspace immediately below the given discrete workspace is displayed on the screen (if there is no discrete workspace below the given discrete workspace in the layout then the given discrete workspace will remain on the screen). Similarly, whenever the mobile user drags the pointing device diagonally northwestward/northeastward/southwestward/southeastward on the screen, the discrete workspace immediately northwestward/northeastward/southwestward/southeastward from the given discrete workspace is displayed on the screen (if there is no discrete workspace northwestward/northeastward/southwestward/southeastward from the given discrete workspace in the layout then the given discrete workspace will remain on the screen).

### 2.0 Additional Embodiments

While the WM technique has been described by specific reference to embodiments thereof, it is understood that variations and modifications thereof can be made without departing from the true spirit and scope of the WM technique. By way of example but not limitation, rather than the first/second prescribed motions being either leftward/rightward motions or upward/downward motions as described heretofore, the first/second prescribed motions can also be other types of motions. More particularly, in one alternate embodiment of the WM technique described herein the first prescribed motion can be a northwestward diagonal motion and the second prescribed motion can be a southeastward diagonal motion. In another alternate embodiment of the WM technique, the first prescribed motion can be a southwestward diagonal motion and the second prescribed motion can be a northeastward diagonal motion. In yet another alternate embodiment of the WM technique, the first prescribed motion can be any motion that moves the vertical axis of the mobile device leftward (e.g., any of the leftward, northwestward or southwestward motions, among others) and the second prescribed motion can be any motion that moves the vertical axis of the mobile device rightward (e.g., any of the rightward, northeastward or southeastward motions, among others). In yet another alternate embodiment of the WM technique, the first prescribed motion can be any motion that moves the horizontal axis of the mobile device upward (e.g., any of the upward, northwestward or northeastward motions, among others) and the second prescribed motion can be any motion that moves the horizontal axis of the mobile device downward (e.g., any of the downward, southeastward or southwestward motions, among others).

Additionally, rather than a data object which is present in a particular discrete workspace that is currently being displayed on the screen being copied to another discrete workspace by the mobile user in the various ways described heretofore, the data object can be moved to another discrete workspace using these ways, or a link (such as a “shortcut” or the like) to the data object can be created within another discrete workspace using these ways. Furthermore, rather than just a single data object being copied or moved to another discrete workspace, or a link to just a single data object being created within another discrete workspace, a group of two or more data objects can be copied or moved to another discrete workspace, or a link to two or more data objects can be created within another discrete workspace. Yet furthermore, while the virtual spatial layout of discrete workspaces embodiment of the WM technique has been described based on the existence of central workspace that represents the mobile device, it is noted that this embodiment can also be implemented without a central workspace. Yet furthermore, rather than the mobile user gesturing with the mobile device using just a single motion in order to select one of the discrete workspaces from the set of two or more discrete workspaces, the mobile user can also gesture with the mobile device using a sequence of two or more motions, where this sequence can include any combination of the various types of motions described herein.

Additionally, the WM technique embodiments described herein can include a stepped zoom feature which generally allows the mobile user to view various groupings of the virtual spatial layout of discrete workspaces by gesturing with the mobile device in prescribed ways. More particularly, and by way of example but not limitation, assume that the overview of the virtual spatial layout of discrete workspaces is currently displayed on the mobile device's screen. Whenever the mobile user gestures with the mobile device using the zoom-in motion, a first subgroup of the discrete workspaces in the virtual spatial layout is displayed on the screen, where the size of the first subgroup is determined based on how far the mobile device is physically moved in this motion. If the mobile user again gestures with the mobile device using another zoom-in motion, a second subgroup of the discrete workspaces in the virtual spatial layout is displayed on the screen, where the second subgroup is a subset of the first subgroup and the size of the second subgroup is determined based on how far the mobile device is physically moved in this motion, and so on. The mobile user can also gesture with the mobile device using the zoom-out motion to reverse this process. In one embodiment of this feature the subgroups are geographic subsets of the overview of the virtual spatial layout of discrete workspaces. In another embodiment of this feature the subgroups are determined based on priorities assigned to the discrete workspaces.

It is also noted that any or all of the aforementioned embodiments can be used in any combination desired to form additional hybrid embodiments. Although the WM technique embodiments have been described in language specific to structural features and/or methodological acts, it is to be understood that the subject matter defined in the appended claims is not necessarily limited to the specific features or acts described heretofore. Rather, the specific features and acts described heretofore are disclosed as example forms of implementing the claims.

### 3.0 Computing Environment

This section provides a brief, general description of a suitable computing system environment in which portions of the WM technique embodiments described herein can be implemented. These WM technique embodiments are operational with numerous general purpose or special purpose computing system environments or configurations. Exemplary well known computing systems, environments, and/or configurations that can be suitable include, but are not limited to, personal computers (PCs), server computers, hand-held devices (such as mobile phones and the like), laptop devices, multiprocessor systems, microprocessor-based systems, set top boxes, programmable consumer electronics, network PCs, minicomputers, mainframe computers, distributed computing environments that include any of the aforementioned systems or devices, and the like.

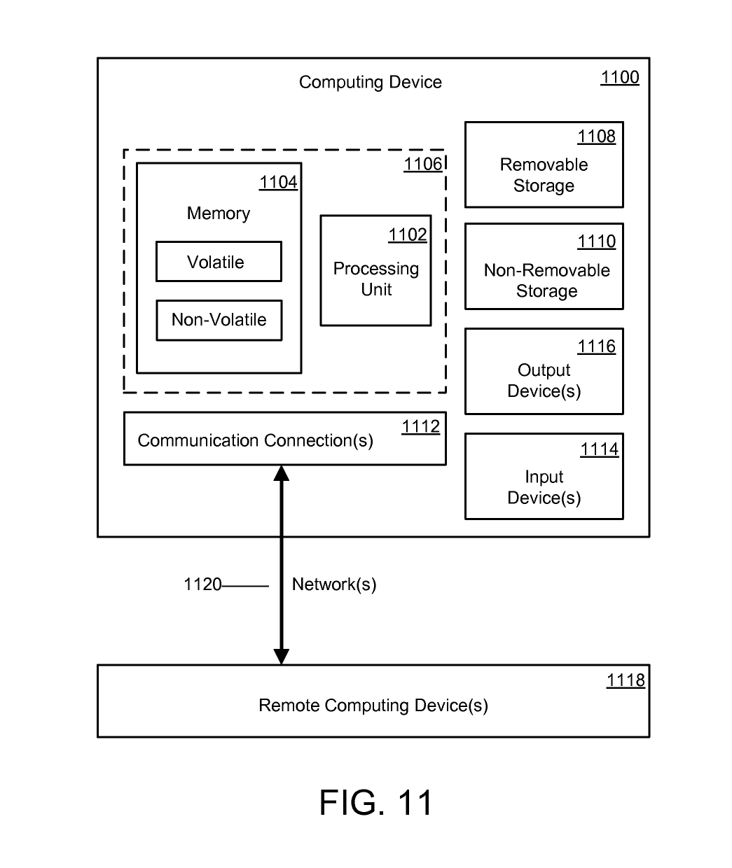

FIG. 11 illustrates an exemplary embodiment, in simplified form, of a suitable computing system environment according to the WM technique embodiments described herein. The environment illustrated in FIG. 11 is only one example of a suitable computing system environment and is not intended to suggest any limitation as to the scope of use or functionality of the WM technique embodiments described herein. Neither should the computing system environment be interpreted as having any dependency or requirement relating to any one or combination of components exemplified in FIG. 11.

As exemplified in FIG. 11, an exemplary system for implementing portions of the WM technique embodiments described herein includes one or more computing devices, such as computing device 1100. In its simplest configuration, computing device 1100 typically includes at least one processing unit 1102 and memory 1104. Depending on the specific configuration and type of computing device, the memory 1104 can be volatile (such as RAM), non-volatile (such as ROM and flash memory, among others) or some combination of the two. This simplest configuration is illustrated by dashed line 1106.

As exemplified in FIG. 11, computing device 1100 can also have additional features and functionality. By way of example, computing device 1100 can include additional storage such as removable storage 1108 and/or non-removable storage 1110. This additional storage includes, but is not limited to, magnetic disks, optical disks and tape. Computer storage media typically embodies volatile and non-volatile media, as well as removable and non-removable media implemented in any method or technology. The computer storage media provides for storage of various information needed to operate the device 1100 such as computer readable instructions associated with an operating system, application programs and other program modules, and data structures, among other things. Memory 1104, removable storage 1108 and non-removable storage 1110 are all examples of computer storage media. Computer storage media includes, but is not limited to, RAM, ROM, EEPROM, flash memory or other memory technology, CD-ROM, digital versatile disks (DVD) or other optical disk storage technology, magnetic cassettes, magnetic tape, magnetic disk storage or other magnetic storage devices, or any other medium which can be used to store the desired information and which can be accessed by computing device 1100. Any such computer storage media can be part of computing device 1100.

As exemplified in FIG. 11, computing device 1100 also includes a communications connection(s) 1112 that allows the device to operate in a networked environment and communicate with a remote computing device(s), such as remote computing device(s) 1118. Remote computing device(s) 1118 can be any of the aforementioned computing systems, environments, and/or configurations, or can be a router, a peer device, or other common network node, and typically includes many or all of the elements described herein relative to computing device 1100. Communication between computing devices takes place over a network(s) 1120, which provides a logical connection(s) between the computing devices. The logical connection(s) can include one or more different types of networks including, but not limited to, a local area network(s) (LAN) and wide area network(s) (WAN). Such networking environments are commonplace in conventional offices, enterprise-wide computer networks, intranets and the Internet. It will be appreciated that the communications connection(s) 1112 and related network(s) 1120 described herein are exemplary and other means of establishing communication between the computing devices can be used.

As exemplified in FIG. 11, communications connection(s) 1112 and related network(s) 1120 are an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, but not limitation, communication media includes wired media such as a wired network or direct-wired connection, and wireless media such as acoustic, radio frequency (RF), infrared, frequency modulation (FM) radio and other wireless media. The term “computer-readable medium” as used herein includes both the aforementioned storage media and communication media.

As exemplified in FIG. 11, computing device 1100 also includes a user interface which includes one or more input devices 1114 and one or more output devices 1116. Exemplary input devices 1114 include, but are not limited to, a keyboard, mouse, pen, touch input device, audio input device (such as a microphone and the like), and camera, among others. A user can enter commands and various types of information into the computing device 1100 through the input device(s) 1114. Exemplary output devices 1116 include, but are not limited to, a display device(s), printer, and audio output devices (such as one or more loudspeakers, headphones, and the like), among others. These input and output devices are well known and need not be described at length here.

Referring again to FIG. 11, the WM technique embodiments described herein can be further described and/or implemented in the general context of computer-executable instructions, such as program modules, which are executed by computing device 1100. Generally, program modules include routines, programs, objects, components, and data structures, among other things, that perform particular tasks or implement particular abstract data types. The WM technique embodiments can also be practiced in a distributed computing environment where tasks are performed by one or more remote computing devices 1118 that are linked through a communications network 1112/1120. In a distributed computing environment, program modules can be located in both local and remote computer storage media including, but not limited to, memory 1104 and storage devices 1108/1110. Still further, the aforementioned instructions could be implemented, in part or in whole, as hardware logic circuits, which may or may not include a processor.

Wherefore, what is claimed is:

1. A computer-implemented process for workspace manipulation on a mobile device comprising a display screen, comprising:
using the mobile device to perform the following process actions:
establishing a set of two or more discrete workspaces;
displaying a default discrete workspace on the display screen, wherein the default discrete workspace comprises one of the discrete workspaces in the set;
whenever a user gestures with the mobile device, using said gesture to select a one of the discrete workspaces from the set; and
displaying the selected discrete workspace on the display screen.

2. The process of claim 1, wherein the process action of displaying the selected discrete workspace on the display screen comprises an action of providing haptic feedback to the user, said feedback notifying the user that what is displayed on the screen has changed.

3. The process of claim 2, wherein either,
(a) the mobile device further comprises a vibration motor, and the process action of providing haptic feedback to the user comprises activating the vibration motor for a prescribed period of time, or
(b) the mobile device further comprises an audio output device, and the haptic feedback is accompanied by either audio feedback, or video feedback, or both audio and video feedback, or
(c) both (a) and (b).

4. The process of claim 1, wherein the set of two or more discrete workspaces is stored as a circular ordered list of discrete workspaces, and the process action of, whenever a user gestures with the mobile device, using said gesture to select a one of the discrete workspaces from the set comprises the actions of:
whenever the user gestures with the mobile device using a first motion, selecting the discrete workspace from said list which immediately succeeds the discrete workspace that is currently being displayed on the display screen; and
whenever the user gestures with the mobile device using a second motion, selecting the discrete workspace from said list which immediately precedes the discrete workspace that is currently being displayed on the screen.

5. The process of claim 4, wherein the display screen is touch-sensitive, further comprising the actions of:
whenever the user touches a data object that is displayed on the screen and then drags said object along the screen in a direction that is associated with the first motion, either,
putting a copy of said object into the discrete workspace from the circular ordered list of discrete workspaces which immediately succeeds the discrete workspace that is currently being displayed, or
moving said object to said discrete workspace from the circular ordered list, or
creating a link to said object within said discrete workspace from the circular ordered list; and
whenever the user touches a data object that is displayed on the screen and then drags said object along the screen in a direction that is associated with the second motion, either,
putting a copy of said object into the discrete workspace from the circular ordered list of discrete workspaces which immediately precedes the discrete workspace that is currently being displayed, or
moving said object to said discrete workspace from the circular ordered list, or
creating a link to said object within said discrete workspace from the circular ordered list.

6. The process of claim 4, wherein the display screen is touch-sensitive, further comprising the actions of:
whenever the user touches a data object that is displayed on the screen and then gestures with the mobile device using the first motion, either,
putting a copy of said object into the discrete workspace from the circular ordered list of discrete workspaces which immediately succeeds the discrete workspace that is currently being displayed, or
moving said object to said discrete workspace from the circular ordered list, or
creating a link to said object within said discrete workspace from the circular ordered list; and
whenever the user touches a data object that is displayed on the screen and then gestures with the mobile device using the second motion, either,
putting a copy of said object into the discrete workspace from the circular ordered list of discrete workspaces which immediately precedes the discrete workspace that is currently being displayed, or
moving said object to said discrete workspace from the circular ordered list, or
creating a link to said object within said discrete workspace from the circular ordered list.

7. The process of claim 4, wherein the display screen is touch-sensitive, further comprising an action of, whenever the user performs a prescribed activity on the screen, moving the current screen content into a new private workspace which is added to the circular ordered list of discrete workspaces, said prescribed activity comprising either,
the user holding a pointing device on the screen while they gesture with the mobile device using either the first or second motion, or
the user dragging the pointing device along the screen in a direction that is associated with either the first or second motion.

8. The process of claim 1, wherein,
the discrete workspaces initially comprise a default private workspace and a shared workspace,
the default private workspace is viewable and manipulatable by just the user,
the shared workspace is collaboratively viewable, manipulatable and annotatable by the user and one or more remote users each of whom are utilizing a computer that is connected to the mobile device via a network,
whenever the mobile device is operating in a collaborative mode, the default discrete workspace comprises the shared workspace, and
whenever the mobile device is not operating in a collaborative mode, the default discrete workspace comprises the default private workspace.

9. The process of claim 8, wherein,
the default private workspace is automatically displayed whenever the mobile device is physically oriented in a first position, and
the shared workspace is automatically displayed whenever the mobile device is physically oriented in a second position that is different than the first position.

10. The process of claim 8, wherein the default private workspace comprises a desktop environment for the mobile device.

11. A computer-implemented process for workspace manipulation on a mobile device comprising a display screen, comprising:
using the mobile device to perform the following process actions:
establishing a virtual spatial layout of discrete workspaces, said layout comprising a plurality of discrete workspaces which are physically arranged in a prescribed geometric pattern around a central workspace that represents the mobile device;
displaying an overview of the virtual spatial layout of discrete workspaces on the display screen, wherein,
the overview comprises a spatial layout of graphical symbols representing the central workspace and each of the discrete workspaces, and
the spatial layout of graphical symbols matches the virtual spatial layout of discrete workspaces such that the overview shows the spatial relationship of each discrete workspace to the central workspace, and also shows the spatial interrelationships between the plurality of discrete workspaces;
whenever a user gestures with the mobile device, using said gesture to select a one of the graphical symbols in the overview; and
displaying the discrete workspace associated with the selected graphical symbol on the display screen.

12. The process of claim 11, wherein the prescribed geometric pattern comprises a two-dimensional array of discrete workspaces, and the process action of, whenever a user gestures with the mobile device, using said gesture to select a one of the graphical symbols in the overview comprises the actions of:
whenever the user gestures with the mobile device using a leftward motion, selecting the graphical symbol immediately to the left of the central workspace;
whenever the user gestures with the mobile device using a rightward motion, selecting the graphical symbol immediately to the right of the central workspace;
whenever the user gestures with the mobile device using an upward motion, selecting the graphical symbol immediately above the central workspace; and
whenever the user gestures with the mobile device using a downward motion, selecting the graphical symbol immediately below the central workspace.

13. The process of claim 11, wherein the prescribed geometric pattern comprises a two-dimensional array of discrete workspaces, and the process action of, whenever a user gestures with the mobile device, using said gesture to select a one of the graphical symbols in the overview comprises the actions of:
highlighting the graphical symbol representing the central workspace;
whenever the user gestures with the mobile device using a leftward motion, highlighting the graphical symbol immediately to the left of the central workspace;
whenever the user gestures with the mobile device using a rightward motion, highlighting the graphical symbol immediately to the right of the central workspace;
whenever the user gestures with the mobile device using an upward motion, highlighting the graphical symbol immediately above the central workspace;
whenever the user gestures with the mobile device using a downward motion, highlighting the graphical symbol immediately below the central workspace; and
whenever the user gestures with the mobile device using a sequence of two or more of any combination of the leftward, rightward, upward and downward motions, moving the highlight from the graphical symbol representing the central workspace to a one of the graphical symbols in the overview based on said sequence.

14. The process of claim 13, wherein the process action of displaying the discrete workspace associated with the selected graphical symbol on the display screen comprises an action of, whenever the user gestures with the mobile device using a zoom-in motion, displaying the discrete workspace associated with the highlighted graphical symbol on the screen.

15. The process of claim 14, further comprising an action of, whenever the user gestures with the mobile device using a zoom-out motion, re-displaying the overview of the virtual spatial layout of discrete workspaces on the display screen.

16. The process of claim 15, wherein either,
the prescribed geometric pattern comprises a two-dimensional array of discrete workspaces, the zoom-out motion comprises the mobile device being moved toward the user, and the zoom-in motion comprises the mobile device being moved away from the user, or
the prescribed geometric pattern comprises a one-dimensional vertical array of discrete workspaces, the zoom-out motion comprises the mobile device being moved rightward, and the zoom-in motion comprises the mobile device being moved leftward, or
the prescribed geometric pattern comprises a one-dimensional horizontal array of discrete workspaces, the zoom-out motion comprises the mobile device being moved upward, and the zoom-in motion comprises the mobile device being moved downward.

17. The process of claim 11, wherein the display screen is touch-sensitive, further comprising the actions of, whenever the user touches a data object that is displayed on the screen and then drags said object along the screen in a particular direction,
using said direction to select a one of the discrete workspaces in the virtual spatial layout, and either,
putting a copy of said object into the selected discrete workspace, or
moving said object to the selected discrete workspace, or
creating a link to said object within the selected discrete workspace.

18. A computer-implemented process for workspace manipulation on a mobile device comprising a touch-sensitive display screen, comprising:
using the mobile device to perform the following process actions:
establishing a virtual spatial layout of discrete workspaces, said layout comprising a plurality of discrete workspaces which are physically arranged in a prescribed geometric pattern around a central workspace that represents the mobile device;
displaying an overview of the virtual spatial layout of discrete workspaces on the display screen, wherein,
the overview comprises a spatial layout of graphical symbols representing the central workspace and each of the discrete workspaces, and
the spatial layout of graphical symbols matches the virtual spatial layout of discrete workspaces such that the overview shows the spatial relationship of each discrete workspace to the central workspace, and also shows the spatial interrelationships between the plurality of discrete workspaces;
whenever a user touches a first one of the graphical symbols representing a first discrete workspace, displaying the first discrete workspace on the display screen.

19. The process of claim 18, further comprising the actions of:
whenever the user gestures with the mobile device using a zoom-out motion, re-displaying the overview of the virtual spatial layout of discrete workspaces on the display screen; and
whenever the user touches a second one of the graphical symbols representing a second discrete workspace, and then drags said symbol along the screen, and then releases said symbol on top of the graphical symbol representing the central workspace, displaying the second discrete workspace on the screen.

20. The process of claim 18, further comprising the actions of, whenever the user drags a pointing device in a particular direction on the display screen,
using said direction to select a one of the discrete workspaces in the virtual spatial layout, and
displaying the selected discrete workspace on the screen.
